(19) United States
(12) Patent Application Publication
(10) Pub. No.: US 2021/0304309 A1
(43) Pub. Date: Sep. 30, 2021

(54) OPTIMIZED GENERALIZED ASSET MIXING PROCESSES FOR CLIENT SPECIFIC PORTFOLIOS USING MULTIPLE DECISION MAKING PERSPECTIVES IN A CLOUD-BASED ENVIRONMENT

(71) Applicant: Michael William Kotarinos, Palm Harbor, FL (US)

(72) Inventor: Michael William Kotarinos, Palm Harbor, FL (US)

(21) Appl. No.: 16/829,139

(22) Filed: Mar. 25, 2020

(51) Int. Cl. G06Q 40/06; G06Q 40/04; G06Q 50/18; G06F 3/0484

(52) U.S. Cl. CPC G06Q 40/06; G06F 3/0484; G06Q 50/184; G06Q 40/04

(57) ABSTRACT

There is a need for dynamic and scalable optimization solutions to allow for generic portfolio construction as a way to enhance portfolio-suitability for clients. In the present innovation, a generalized asset mixer is optimized for client-specific portfolios by incorporating multiple decision-making perspectives in a cloud-based environment. First, the client specifies the constraints by which they wish to construct their portfolio, resulting in a metric which encompasses client preferences. Then, techniques that best encapsulate this metric are used to construct technique-based portfolios. Based on the importance of each of these constraints, a weight is assigned to each individual portfolio in order construct one master-portfolio which includes all common assets in each of the technique portfolios along with other unique assets that are determined through a modified Metropolis-Hastings procedure and, if the frame diverges, an additional Markov Chain weighting iterative procedure. Finally, a last criteria is used in order to globally optimize the portfolio to this specific technique, as it is locally optimal to multiple different techniques. A robustness check which varies attributes of the process such as technique weights and the number of assets in the final portfolio is used to present to the client multiple different options.

### FIELD OF THE INVENTION

The present invention is directed generally to an optimization process for different portfolio construction techniques that combines multiple approaches together for optimal portfolios in a scalable cloud-based environment.

### BACKGROUND OF THE INVENTION AND DESCRIPTION OF THE RELATED ART

The present invention relates to a generalized asset mixer that is optimized for client-specific portfolios by incorporating multiple decision-making perspectives in a cloud based environment. A client may specify a plurality of criteria they desire to build a portfolio. The platform constructs a metric which encompasses client preferences based upon the selected plurality of criteria. The platform opts for techniques that are comparable and complement the metric for a particular client to construct technique based portfolios. The client may also weigh the criteria and based upon the importance of each criteria selected by a client, the platform formulates weights to be assigned to each portfolio. A master portfolio is constructed which includes all common assets in each of the technique based portfolios. The master portfolio contains all common assets in each of the individual technique portfolio and the platform may add other unique assets to the master portfolio based on an analysis and determination using a modified Metropolis-Hastings procedure to develop a frame. The platform conducts an inquiry to determine if a frame diverges, and, if it is determined that the frame diverges the platform, conduct an additional Markov Chain weighing iterative procedure on the master portfolio. If the frame does not diverge, but rather converges, the master portfolio is developed from the frame. A final criteria for a specific technique is applied to the master portfolio to globally optimize the master portfolio to the specific technique. This process generates a final master portfolio that is locally optimal to multiple different techniques. The platform conducts a robustness check which varies attributes of the process such as the technique weights and the number of assets in the final master portfolio to create different options for a final portfolio which is presented to the client.

The present invention pertains to the method for developing a unique platform to enhance the portfolio selection technique based upon certain desire criteria. The platform institutes identity metrics to construct a plurality of technique portfolios. The technique portfolios are associated with a weight determined by the criteria selected by a client. Common assets may be added to a master portfolio. The master portfolio is created using the final assets as well as assets from the technique portfolios. A modified Metropolis-Hastings sampler is applied to the master portfolio. The cases generated by the Metropolis-Hastings sampler are applied to a Markov Chain weighting process to generate a final master portfolio. A final criteria is applied to the final master portfolio to generate a final portfolio, which is then tested for robustness.

The present invention solves the problem of the prior art which was focused on single asset selection and fail to properly consider the risk or reward deviation.

One of the fundamental concepts of modern portfolio theory and modern finance in Elton, Edwin J., and Martin J. Gruber. “Modern portfolio theory, 1950 to date.” Journal of Banking & Finance 21.11-12 (1997): 1743-1759 is the idea of creating a portfolio of diverse assets to better manage risk, return, suitability, and other criteria than would occur by owning just a single asset. By mixing assets together, one can achieve a better mix than would be possible by just holding a single asset. This has led to a shift from focusing on single asset picking to asset mixes, which has led to the rise of investment vehicles such as exchange traded funds Madhavan, Ananth, and Aleksander Sobczyk. “Price dynamics and liquidity of exchange-traded funds.” Journal of Investment Management 14.2 (2016): 1-17.

One of the difficulties in the single asset approach is that it typically only focused on the relationship between risk and return. The capital asset pricing model provided a framework for thinking about risk and return. However, while this formulation was easy to use, its theoretical basis was found to have major issues which causes concerns about the level of appropriateness of the portfolios suggested Lewellen, Jonathan, and Stefan Nagel. “The conditional CAPM does not explain asset-pricing anomalies.” Journal of financial economics 82.2 (2006): 289-314.

The approaches in the prior art penalize the return of a portfolio above the risk-free rate by the level of volatility, represented as the estimated standard deviation of the portfolio. One of the issues with the prior art approaches is they assume that the entirety of risk can be represented by the standard deviation and past trends, which is misleading Taleb, Nassim Nicholas. “Black swans and the domains of statistics.” The American Statistician 61.3 (2007): 198-200.

The present innovation improves upon some techniques from statistical sampling theory. The Markov Chain Monte Carlo (MCMC) approach is an extension of traditional Monte Carlo techniques for exploring high dimensional spaces Van Ravenzwaaij, Don, Pete Cassey, and Scott D. Brown. “A simple introduction to Markov Chain Monte-Carlo sampling.” Psychonomic bulletin & review 25.1 (2018): 143-154. One of the most well-known techniques for use in an MCMC environment is the Metropolis-Hastings algorithm, which explores how the Markov Chain is explored Medina-Aguayo, Felipe J., Anthony Lee, and Gareth O. Roberts. “Stability of noisy metropolis-hastings.” Statistics and Computing 26.6 (2016): 1187-1211. However, the MCMC techniques have not been applied to building a master portfolio as implemented in the present invention.

The prior art allows one to trade-off between exploring lots of the chain but spending more time in areas that are not as fruitful (low probability space) versus spending time exploring less of the chain but sticking to high probability areas. For example, a special case of the Metropolis-Hastings algorithm is the Gibbs Sampler Casella, George, and Edward I. George. “Explaining the Gibbs sampler.” The American Statistician 46.3 (1992): 167-174, which chooses to agnostically explore the entire space (that is, a weight of 1 towards exploration). However, the prior art approach is typically applied to simulation and integral estimations rather than a statistical characterization of the underlying fundamental architecture of a space Robert, Christian P., and Kerrie L. Mengersen. “Reparameterisation issues in mixture modelling and their bearing on MCMC algorithms.” Computational Statistics & Data Analysis 29.3 (1999): 325-343. As such, the prior art techniques must be modified with a new approach to allow for architectural characterizations in a big data cloud environment.

The present invention extends into an asset selection environment and tying it to a client's unique goals, new and innovative platforms can be created for asset management. For example, the Data Shapley approach for data management can be used as an asset selection approach and combined with other techniques for the selection of assets. Some examples of such techniques are using machine learning to cluster assets into segments, a long-short portfolio construction hedge (as often seen in hedge funds), and the aforementioned Data Shapley approach. While there are some methods for asset mixing Zhang, Fan, and Zhichao Zhang. “Strategic asset allocation by mixing shrinkage, vine copula and market equilibrium.” Journal of Forecasting 37.3 (2018): 340-351, none of them address the issues faced regarding local versus global optimality, implementation speed, generic implementation across newly created portfolio perspectives and making this technology accessible in an easy to use environment for non-technically advanced clients Martins, Carolina Lino, et al. “Scaling issues in MCDM portfolio analysis with additive aggregation.” International Conference on Decision Support System Technology. Springer, Cham, 2016.

U.S. Pat. No. 10,453,141 focuses on the creation of new personal composite indexes. The approach of the '141 Patent is primarily a long-short mixing tool of various assets. As such, it is not explicitly built to take a dynamic metric, scale into a cloud environment, and take dynamically created portfolios that embody principles beyond the traditional risk-return methodology seen in most portfolios.

U.S. Pat, No. 10,453,142 focuses on the analysis of risk using Monte Carlo risk simulation. Additionally, it focuses on a computer-integrated system in order to quantify and perform further risk analysis. This approach utilizes the Sharpe ratio, which assesses the risk relative to the value of an asset, and a Monte Carlo procedure. However, it is limited only to risk and does not utilize the Markov Chain Monte Carlo procedure. The present invention utilizes the MCMC procedure to understand a broad range of metrics. In other words, the present invention uses not only the analysis of risk, but combines this analysis with multiple different metrics to produce a well-rounded portfolio. In this process, techniques beyond just the Sharpe Ratio and Monte Carlo procedure are used, such as Data Shapley, Metropolis-Hastings, and Markov Chain Monte Carlo.

U.S. Pat. No. 7,870,051 features portfolio construction based on preferences of which kind of assets to include in the portfolio (i.e. stocks, bonds) and weighting them. Then, a risk analysis procedure is used to construct the final portfolio. The present innovation improves upon this by allowing the client not only to choose which kind of assets they prefer, but other criteria such as their market cap, the country they come from, how they view different trade-offs and other criteria. The final construction of the portfolio is then based not only on risk, but several different procedures that are most appropriate to the client's preferences.

U.S. Pat. No. 6,275,814 analyzes a process to create a portfolio with the aid of a computer algorithm that uses industry sector and risk-adjusted performance in order to produce a final portfolio. However, the patent fails to use any metric other than risk analysis to construct the final portfolio. The '814 Patent cannot combine multiple different strategies into final portfolio implementation such as the present innovation. The present invention overcomes the problem of taking into account all the client's desired investment styles, by using multiple techniques (thus the creation of the technique portfolios), which this innovation does not do.

U.S. Pat. No. 10,453,140 is a computerized method of portfolio construction for a retired audience in order to help them better understand the trade-off between risk and return. It utilizes a Monte Carlo simulation and modern portfolio theory to construct an optimal portfolio based on risk analysis. However, the present invention improves upon this idea by combining multiple techniques and taking into account multiple client preferences, thus extending the target audience from those who are retired to a much broader perspective. The present invention requires the mixing of several different portfolio-construction strategies and the use of the Markov Chain Monte Carlo weighting process in the method to create a final portfolio which is then tested for robustness.

### SUMMARY OF THE INVENTION

The present invention extends the traditional approach of constructing a portfolio by combining different portfolio selection techniques based on desired criteria. By allowing a customizable selection and importance given to techniques used to construct a portfolio, this innovation improves upon current implementations. This innovation derives improvements by allowing multiple perspectives to be considered, and thus the resulting portfolios better address the unique needs of the client. As each client is unique so too is the perspective from which their portfolio is derived. The resulting implementation is scalable into cloud computing environments and allows for dynamic and robust portfolio construction. This is achieved through a multiple step process:
1. Identifying the metric by which the client wishes to construct their portfolio.
2. Using different techniques to construct corresponding portfolios.
3. Determining the importance of each portfolio based on client's preferences.
4. Adding the stocks common to all portfolios at the lowest common weight to a final master-portfolio.
5. Choosing the number of assets to include in the final portfolio.
6. Determine which assets to use from each technique portfolio based on the predetermined weights from step 4.
7. Use a customized modified Metropolis-Hastings sampler using assets identified from step 6 in an iterative process, resulting in two cases:
   a. Portfolio converges, in which case this portfolio is accepted as a master-portfolio.
      b. Portfolio fails to converge, in which case a Markov Chain weighting process over different state portfolios is used to determine a master-portfolio.
8. Use the final criteria on the master-portfolio round-out the portfolio construction, resulting in a final portfolio.
9. Evaluate the robustness of the final selection by considering different portfolio sizes and asset, metric, and technique weights.
10. Use the robustness test to present to the client different portfolio options.

### BRIEF DESCRIPTION OF THE DRAWINGS

Certain embodiments are disclosed with reference to the following drawings:

FIG. 1 illustrates a block diagram representing the processing platform for an exemplary embodiment of the present invention;

FIG. 2 illustrates examples of an interface for an exemplary embodiment of the present invention demonstrating the selection process for client criteria;

FIG. 3 illustrates an example of the master-portfolio weighting process for the present invention;

FIG. 4 is an example of a flow-chart for a convergent process utilizing the modified Metropolis-Hastings sampler; and

FIG. 5 is an example of a flow-chart for a divergent process utilizing a Markov Chain weighting process.

### DETAILED DESCRIPTION OF THE PREFERRED EMBODIMENTS

Unless defined otherwise, technical and financial terms used herein have the same meaning as commonly used in the financial planning industry.

There is a need for dynamic and scalable optimization solutions to allow for generic portfolio construction as a way to enhance portfolio-suitability for clients. In the present innovation, a generalized asset mixer is optimized for client-specific portfolios by incorporating multiple decision-making perspectives in a cloud-based environment. First, the client specifies the criteria by which they wish to construct their portfolio, resulting in a metric which encompasses client preferences. Then, techniques that best encapsulate this metric are used to construct technique-based portfolios. Based on the importance of each of the specified criteria, a weight is assigned to each individual portfolio in order construct one master-portfolio which includes all common assets in each of the technique portfolios along with other unique assets that are determined through a modified Metropolis-Hastings procedure and, if the frame diverges, an additional Markov Chain weighting iterative procedure. Finally, a last criteria is used in order to globally optimize the portfolio to this specific technique, as it is locally optimal to multiple different techniques. A robustness check which varies attributes of the process such as technique weights and the number of assets in the final portfolio is used to present to the client multiple different options.

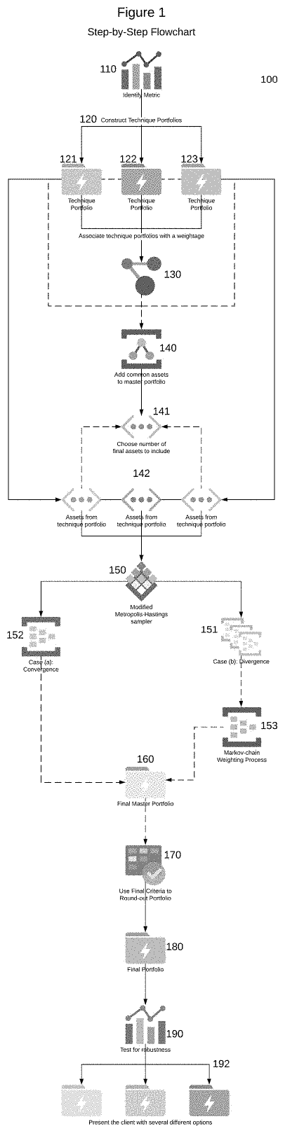

An overview of this process can be seen in FIG. 1.

FIG. 1 is a flowchart of the overall process for a platform for an asset mixing process for client specific portfolios using multiple decision-making perspective in a cloud-based environment. The platform 100 first identifies a metric by which to construct a portfolio. In the example detailed by FIG. 1, there are three appropriate techniques that can be used to construct a portfolio based on the preferences conveyed by the metric. Each technique then leads to the construction of what is called a “technique portfolio,” 120 where each technique portfolio 121, 122 and 123 contain assets that optimize its respective criteria selected by the client. Depending on the client's preferences for selected criteria, each technique portfolio 121, 122 and 123 are then assigned a weight 130 which describes its relative importance. A master-portfolio 140 is then created which contains all assets found common to each of the technique portfolio 121, 122 and 123 at the lowest common weight. The platform 100 selects the number of final assets 141 to include in the master-portfolio 140. Assets 142 from the technique portfolios 121, 122 and 123 may also be added to the master-portfolio 140. A modified Metropolis-Hastings procedure 150 to determine which assets unique to the individual technique portfolios should be added to the final master portfolio 160. The results may form one of two types of frames: a divergence 151 or convergence 152. When the results form a frame that converges, the 152 results are used to generate a final master-portfolio. When the results form a frame that diverges, a divergent 151 master portfolio can be modified using Markov Chain weighting procedures 153 to then generate the final master-portfolio 160. A final technique 170 may be applied to the master-portfolio 160, resulting in a final portfolio 180. At the beginning of the process, a weight of the techniques and number of assets were determined with respect to the client's preferences. Thus, a test for robustness 190 can be performed in order to vary these asset number values and weights in order to present the client with multiple options. In the example of the figure, there are three final options that are presented to the client 192.

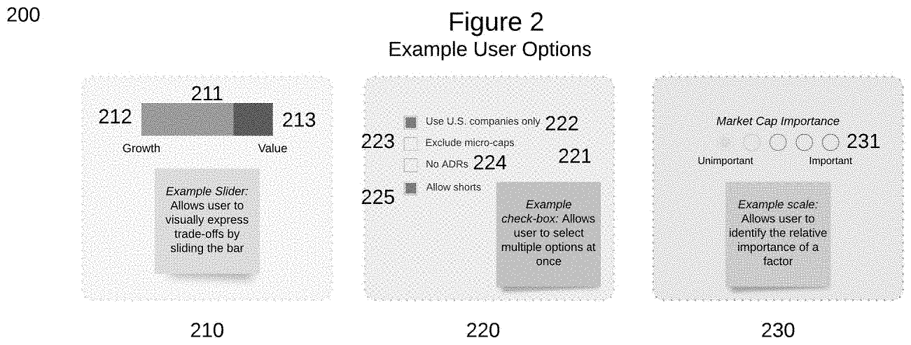

FIG. 2 depicts examples of how a user interface 200 operates in choosing unique options which may appear. The first screen 210 demonstrates an example slider 211. A user can decide the relative importance of growth 212, which comes at a trade-off with value 213. The user moves the slider in their final portfolio by moving the slider 211 or the bar to an appropriate location. The slider 211 allows the user to visualize the trade-offs by sliding the bar; i.e., more growth equates to less value. Similarly, the second screen 220 illustrates an example in which check-boxes 221 can be used. A client can decide whether they want U.S. companies only 222, whether they wish to exclude micro-caps 223 or ADRs 224, and whether they wish to allow shorts 225. Because this is represented by check-boxes 221, the user can choose as many options that suit their individual needs. Finally, the last screen 230 depicts an example of where a scale 231 may be used. This is when a user determines the relative importance of something, but unlike a slider 211, not at a trade-off with anything else. The scale 231 permits the user to identify the relevant importance of a factor. In the example presented in FIG. 2, a client can choose how important the market cap 230 is in their portfolio construction. Because of the use of various different options such as sliders 211, check-boxes 221, and scales 231, a client can be presented with options that come at a trade-off, choose multiple options at once, or identify the relative importance of a certain constraint. More sophisticated users can also opt for an Application Programming Interface (API) to send numeric representations of these choices directly into the system via API calls to a server, which is commonly done at quantitatively based advising services such as robo-advisors. While sliders 211, check-boxes 221 and scales 231 are disclosed, in the preferred embodiment there are numerous ways for a client to enter the selected criteria for a portfolio into the platform 100.

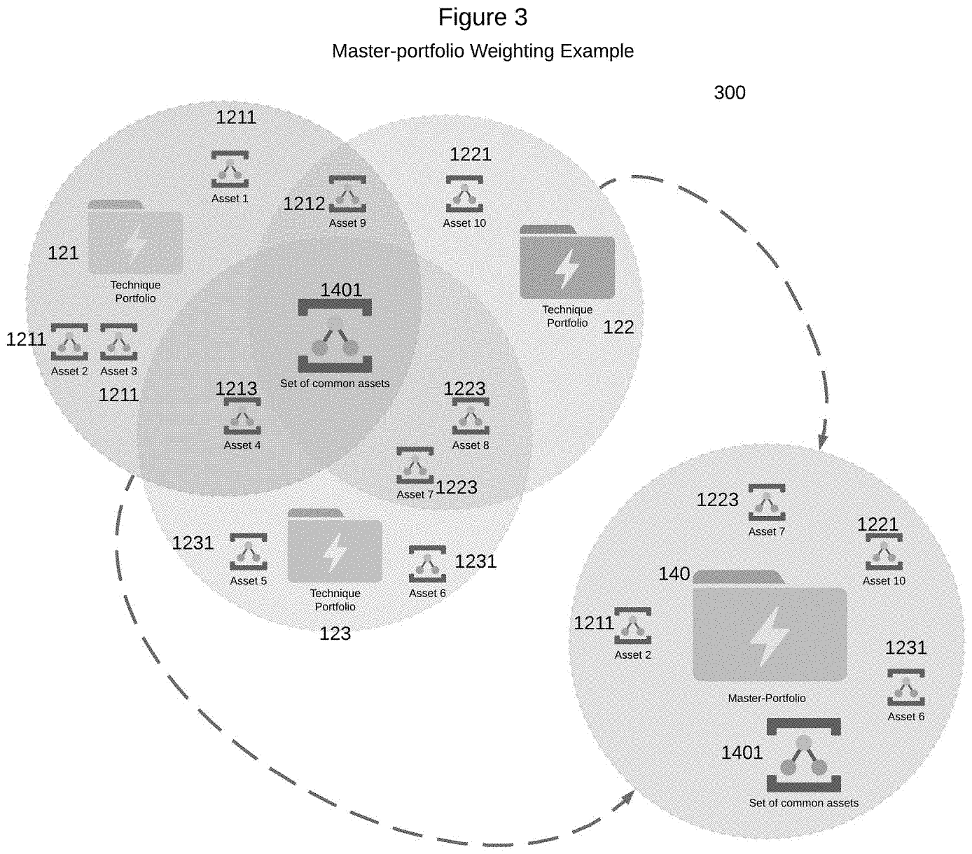

FIG. 3 details an example of the creation of a master-portfolio 140 from FIG. 1. The master portfolio weighting example 300 of FIG. 3 depicts a first technique portfolio 121 which includes asset 1211, a second technique portfolio 122 which includes assets 1221, and third technique portfolio 123 which includes assets 1231. There may be common assets 1213 between the first technique portfolio 121 and the second technique portfolio 123. Likewise, there may be common assets 1223 between the second technique portfolio 122 and the third technique portfolio 1223. Finally, there may be common assets between the first technique portfolio 121 and the third technique portfolio 1212. The assets common to all three technique portfolios 121, 122 and 123 comprise the set of common assets 1401. The master portfolio 140 comprises or assets formulated from the set of common assets 1401, as well as assets common to techniques 1 and 2 (1213), techniques 1 and 2 (1212) and techniques 2 and 3 (1223). In the example presented, there are three technique portfolios 120, all overlapping with a set of common assets 1401. Additionally, one technique portfolio 120 contains, unique to itself, assets 1211. Unique to two technique portfolios is asset 1213. Another technique portfolio, unique to itself contains assets 1231. Common between two other technique portfolios are assets 1223. The last technique portfolio contains asset 1221 unique to itself, but asset 1212 shared with another technique portfolio.

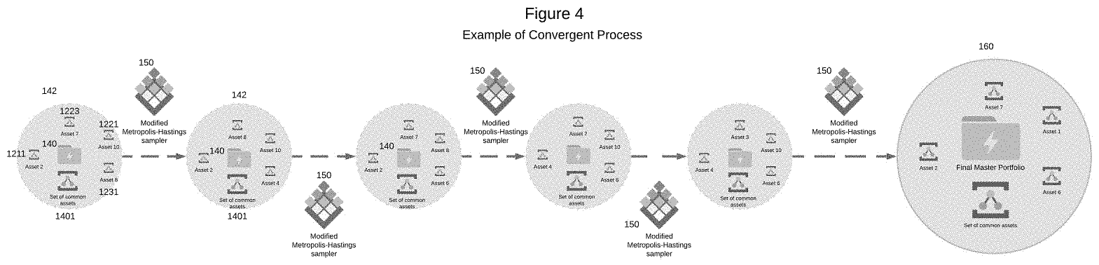

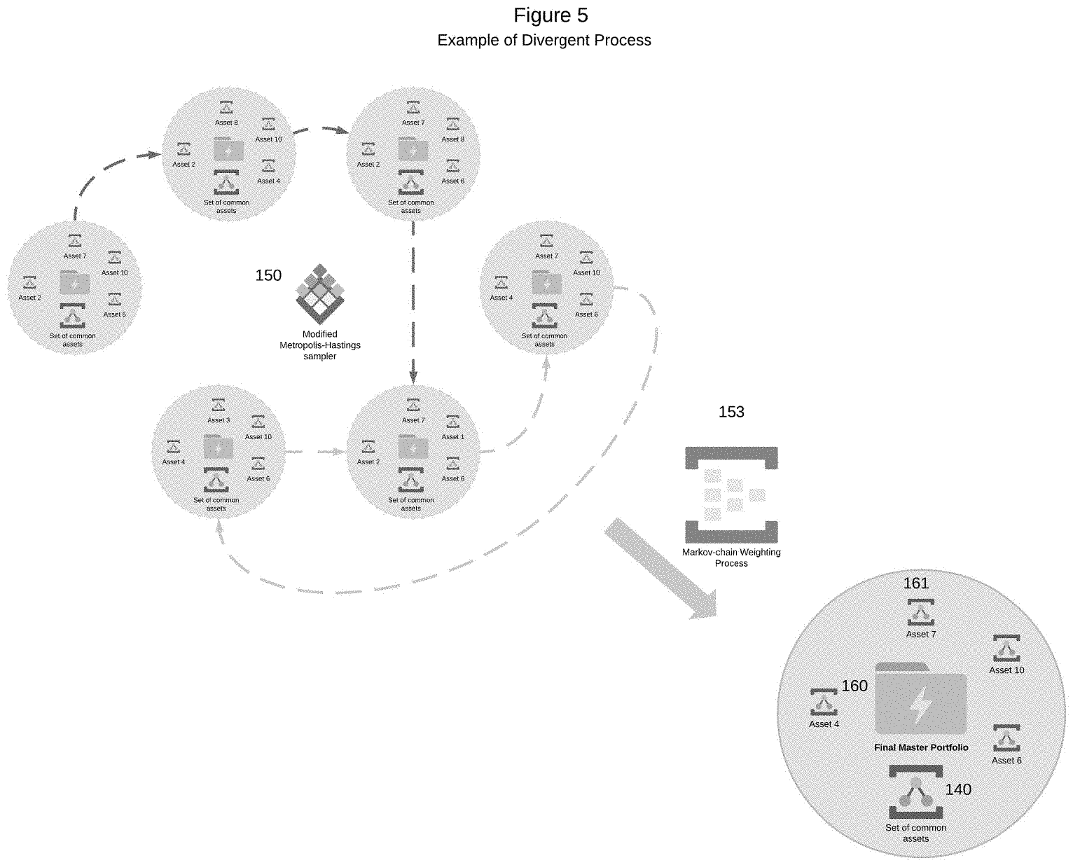

FIG. 3 demonstrates the creation of the master portfolio 140 which may contain the set of assets that are common to all three technique portfolios 1401, at the lowest common weight. Additionally, the master portfolio contains assets 1211, 1231, 1223 and 1221. This is determined by the modified Metropolis-Hastings procedure 153. The next step is determined by whether an iterative process on this portfolio converges or diverges with these two cases detailed in FIGS. 4 and 5.

FIG. 4 depicts an example of the Metropolis-Hastings procedure 153 being applied to the master portfolio 140, and demonstrate how they converge into one final master portfolio 160. In this example, the Metropolis-Hastings sampler 150 is applied in an iterative process, totally consisting of five steps before the assets in the final master portfolio 160 do not change. In each step, some of the assets in the portfolio change as the process searches for an optimal portfolio that embodies the fundamentals of the aforementioned technique portfolios 121, 122 and 123. This process continues until the final master portfolio 160 is reached, at which time no further improvements can be made. As seen in this example, the final master portfolio contains assets 142 and the set of common assets initially determined 160.

FIG. 5 depicts the case where the Metropolis-Hastings procedure 153 may not result in a final convergence. As seen in FIG. 5, the sampler 153 leads to a set of portfolios that form a cycle when the Metropolis-Hastings procedure 150 is iteratively applied to each stage of the process. In this case, a Markov Chain weighting process 153 is used to determine the final assets 161 that appear in the final master portfolio 160. In this case, the final master portfolio 160 contains the set of common assets 140, and assets 161. This is because when the Metropolis-Hastings sampler results in a cycle of three portfolios, each of assets 161 are found in two of the stages of this cycle. The selection of assets from the Markov Chain portfolios 153 is done using a weighted average process proportional to the frequency of how often the states are visited after the algorithm has run for a certain number of steps (after the “burn-in” period), and therefore the assets present in the final master-portfolio are, on average, the assets that occur most frequently in the cycle that the modified Metropolis-Hastings 150 sampler results in.

In the platform of the current invention, the first step involves identifying the preferred metric 110 by which a client wishes to construct their portfolio. Because the needs of each client are unique, the preferences in the criteria the client may wish to use to construct a portfolio differ from one client to the next. Therefore, the goal of step (110) is to identify the features inherent to each individual and then subsequently metricize them based on how much each criteria is valued relative to each other. The user interface presented to the client will include a mix of sliders 210, check-boxes 220, and scales 230 to help tailor the program to their individual needs. This also allows for an Application Programming Interface (API) implementation for advanced users. FIG. 2 demonstrates an example of what may be presented to a user 200. This approach extends upon previous designs as the platform to solicit information from a user in various forms that allow for complex methodologies and techniques to be made accessible to a wide audience.

Once the preferred criteria of a user is obtained, it is important to identify how to take these preferences into consideration. In step 2, the metric that is derived for an individual in step 1 is used to make different technique portfolios 120. Each of these different portfolios technique 120 is the representation of a different approach to portfolio construction. Just as each individual and their preferences are unique, so too are many financial institutions and investment firms unique. For example, some firms focus on long-short strategies, some try to time the market, and some focus on long-term investments. Each of these techniques portfolios 120 represents a different approach and a different strategy. In step 2, the metric derived in step 1 based upon the criteria of the user is implemented to create technique portfolios 120 that correspond to the different approaches that can be taken in order to construct a portfolio.

In step 3, the technique portfolios constructed in the previous step that represent different approaches to investing are weighted 130. In this process, the platform assesses the level of appropriateness for each approach for a client. For example, a long-short portfolio may not be appropriate for a client so this may receive a weight of zero. On the other hand, for another client, this long-short portfolio may not be an ideal investment vehicle but is a viable option, so it may receive a weight of 0.1 relative to a weight of 0.9 given to a Data Shapley portfolio. This process expands on the information given in step 1 and is based on the financial professional's understanding of the needs and desires of the client. As such, each client will have a mix of unique weights representing their unique preferences based upon the criteria entered by a client. One criteria in step 3 is omitted, and is referred to as the master criteria. Usually, this will be the criteria that is considered most important, or the criteria that encompasses the various perspectives considered. This improves upon previous techniques by allowing the use of methods such as data-driven statistical techniques in combination with traditional financial methods, machine learning approaches, and new innovative techniques as they are developed for consistent portfolios that embody the fundamentals of the underlying approaches.

Once these weights are identified, step 4 obtains the stocks common to all portfolios and adds them to a single master-portfolio 140, each given the lowest common weightage.

In step 5, the system planner chooses an estimate of the appropriate number of assets 141 to include in the final portfolio 180. For example, a financial analyst may have to weigh between the trade-off of presenting a portfolio with fewer assets, but ones which are more directly tailored to the client's needs, or a portfolio with a larger number of assets, which allows for more diversification but a less specific selection.

Step 6 further adds assets to this master-portfolio 140 by choosing a proportion of the highest scoring stocks from the various portfolios based on their weightage. For example, if it is determined in step 5 that the master-portfolio 140 should contain 10 assets, and there are already 2 common assets in the portfolio, and a certain technique portfolio 120 is valued with a weight of 0.5, the top 4 scoring assets in this technique portfolio 121 would be chosen. FIG. 3 shows an example of this process.

In step 7, a modified Metropolis-Hastings algorithm 150 is run on the generated portfolio 142. When different perspectives are combined, the resulting master-portfolio 151 or 152 may no longer represent the underlying world views and fundamentals that originated from the original portfolios 120. For example, a Data Shapley portfolio feeding into a master portfolio may result in lower Data Shapley values than when evaluated individually within its own portfolio because of its mixing with a long-short hedge portfolio, and likewise the long-short hedge may not no longer have proper hedges and uncorrelated returns to the market. As a result, it is necessary to re-optimize and recalibrate the portfolio after mixing. This process is done by using a modification to a Metropolis-Hastings algorithm 150. As an example, consider using a Gibbs sampling approach (a kind of Metropolis-Hastings algorithm). Suppose a weight is given of 80% to the Data Shapley approach and 20% to the long-short approach. The new master portfolio can be evaluated in terms of the Data Shapley entrants, and if it is possible to improve the Shapley score of the portfolio by changing out one of the Data Shapley positions or changing a weight on a Data Shapely position, this can be done. This can also be performed for the long-short mixes. However, the portfolio should take more consideration of the Shapley mix rather than the long-short mix. As such, for every one rebalance to a long-short mix the rebalancer should search for four changes for the Data Shapley mix. In this Gibbs sampling example, we would do four Shapley rebalances, then a long-short rebalance, then another four Shapley rebalances, another long-short rebalance, and so on. There are two possible outcomes of this procedure:
(a) This process would either continue until a stable portfolio is reached, which is referred to as convergence of the algorithm 152.
(b) It is possible the portfolio may not converge 151. This is referred to as divergence. In the case of divergence, we would consider which portfolios the rebalancer is moving between. These different states can be considered to be states in a Markov Chain which is moving between states. The resulting portfolio will encompass and encapsulate these states with a weighting process. The more frequently a state is visited (e.g. the more often we see a portfolio in the rebalancer) the more weight it is given. The ending master portfolio 160 will thus be a weighted average of the visited portfolios in the Markov Chain procedure 153.

FIGS. 4 and 5 further exemplify this process. Step 8 applies the identified master criteria 170 to the master-portfolio 160 in order to create a final portfolio 180. According to the number of assets desired in the final portfolio 180, the master criteria's 170 weight is used to determine which final assets are used in the portfolio. This is done in order to make sure the portfolio is optimal based on one final technique with regards to the multiple different perspectives used in its construction. In other words, the final portfolio can be thought of as locally optimal with respect to many criteria but globally optimal with respect to this final criteria. For example, if the identified master criteria is the Sharpe Ratio, the final portfolio will maximize the Sharpe Ratio given the number of assets left to fill into the master portfolio. This extends and improves upon existing approaches by allowing for locally optimal portfolios that embody principles of many approaches and a globally optimal portfolio that embodies the principles of a specific approach, as such allowing global optimality features with some additional local optimality.

Steps 1-8 construct a final portfolio 180 using selected weights for techniques and metrics, and a specific number of assets for the portfolio. Step 9 then evaluates the robustness 190 of these values, thus constructing a variety of portfolios by slightly varying these weights and the final desired number of assets. In this way, several different final portfolios can be constructed using the process detailed above. In the robustness check, data analytics and machine learning are used to analyze these different portfolios to determine patterns, trends, and similarities of interest. This robustness construction presents a new innovation in the presentation of new portfolio options to clients. This improves upon existing approaches of simply offering the client a limited offering such as low, medium, and high-risk portfolios by quickly allowing for dynamic portfolio creation and offerings. For example, a client could offer portfolio options with low, medium, and high risk to emerging markets, low, medium, and high liquidity, and so on in combination with each other (e.g. low risk and high liquidity). This allows the planner the choice of offering many options or few options, depending on his or her relationship with the client and the client's decision making process.

In step 10, the robustness checks 190 allow for multiple portfolios 192 to be presented to the client for consideration. A traditional use of this robustness check 190 would be changing the weights on the Sharpe optimizer to present low, medium, and high-risk portfolios to a client. In this dynamic environment, this can be extended to any of the criteria and perspectives used in the portfolio creation process. As an example, this could result in portfolios with a strong long-short dimension, a medium amount of long-short mixes and a low amount of exposure to long-short. The end result of this is that the financial planner can discuss various options with his client, show him various possible portfolios, and in the process, learn more about the client's unique needs. This process of learning more about client needs can further be used to refine weights used in future portfolio construction in this process. This refinement allows for continuous improvement in the portfolio construction and presents a significant innovation in the process of managing client assets.

1. A computer implemented method of generating a technique-based final portfolio of assets for a client, the method being implemented on an apparatus comprising at least one processor, at least one memory and a computer program code configured to cause the apparatus to perform the steps comprising:
creating a database of a client preferences based on a variable number of criteria stored in the memory;
selecting one criteria as a final criteria;
identifying a metric to construct a portfolio containing a plurality of assets;
constructing a plurality of technique portfolios using a plurality of techniques, wherein each of the plurality of technique portfolios includes a plurality of assets;
classifying the plurality of technique portfolios based upon the client preferences;
constructing a master portfolio containing a plurality of master portfolio assets comprising assets common to the plurality of technique portfolios;
selecting a number of assets to include in a final portfolio;
determining which of the assets from the master portfolio should be used in the final portfolio using a customized Metropolis-Hastings sampler in an iterative process the results of which are processed in the processor to determine an outcome: if the plurality of the master portfolio assets converge utilizing the assets to form a final master portfolio, alternatively, if the plurality of the master portfolio assets fail to converge, utilizing a Markov Chain weighting process over a variable state portfolio of the master portfolio to form a final master portfolio;
applying the final criteria to the final master portfolio to create a final portfolio;

2. The computer implemented method of generating a techniques-based final portfolio of claim 1, further comprising the step of utilizing a robustness test to present a client with different portfolio options for the final portfolio.

3. The computer implemented method of generating a techniques-based final portfolio of claim 2, further comprising the step of evaluating the robustness of the final portfolio by considering portfolio size, metrics and techniques.

4. The computer implemented method of generating a techniques-based final portfolio of claim 3, further comprising the step of generating a client specific procedure based on the variable number criteria to create a unique metric used to classify the plurality of technique portfolios.

5. The computer implemented method of generating a techniques-based final portfolio of claim 2, further comprising the step of using a user interface comprising of sliders to create the database of client preferences.

6. The computer implemented method of generating a techniques-based final portfolio of claim 2, further comprising the step of using a user interface comprising of check-boxes to create the database of client preferences.

7. The computer implemented method of generating a techniques-based final portfolio of claim 2, further comprising the step of using a user interface comprising of scales to create the database of client preferences.

8. The computer implemented method of generating a techniques-based final portfolio of claim 2, further comprising the step of using a user interface comprising of sliders, check-boxes and scales to create the database of client preferences.

9. The computer implemented method of generating a techniques-based final portfolio of claim 2, further comprising the step of constructing the plurality of technique portfolios in a cloud-computing environment.

10. The computer implemented method of generating a techniques-based final portfolio of claim 2, wherein the Metropolis-Hastings sampler incorporates a plurality of different perspectives in a multi-user decision-making environment.

11. The computer implemented method of generating a techniques-based final portfolio of claim 2, wherein the Markov Chain approaches for a weighing process in a generalized non-convergent framework.

12. The computer implemented method of generating a techniques-based final portfolio of claim 11, wherein the step of determining which of the assets from the master portfolio utilizes an iterative process.

13. The computer implemented method of generating a techniques-based final portfolio of claim 2, wherein the step of evaluating the robustness of the final portfolio by utilizing machine learning and artificial intelligence.

14. The computer implemented method of generating a techniques-based final portfolio of claim 3, wherein the steps of the process are conducted on a cloud-based environment for dynamic, scalable and computational solutions.

15. The computer implemented method of generating a techniques-based final portfolio of claim 1, further comprising the steps of:
providing a weight to each of the plurality of technique portfolios; and
adding assets to the master portfolio based upon the weight provided to the plurality of technique portfolios.

16. The computer implemented method of generating a techniques-based final portfolio of claim 1, wherein the assets comprise stocks.

17. The computer implemented method of generating a techniques-based final portfolio of claim 16, wherein the assets further comprise bonds.

18. The computer implemented method of generating a techniques-based final portfolio of claim 1, wherein the assets comprise stocks.

19. The computer implemented method of generating a techniques-based final portfolio of claim 1, wherein the steps of the process are carried out on a scalable cloud-based API implementation.

20. The computer implemented method of generating a techniques-based final portfolio of claim 4, wherein the step of classifying the plurality of technique portfolios are constructed generally simultaneously in a cloud computing environment.
